(19) United States
(12) Patent Application Publication
(10) Pub. No.: US 2025/0180831 A1
(43) Pub. Date: Jun. 5, 2025

(54) PLUGGABLE MULTIFIBER CONNECTOR MODULE

(71) Applicant: Senko Advanced Components, Inc., Hudson, MA (US)

(72) Inventors: Philip WARD, Basingstoke (GB); Siu Kei MA, Kowloon (HK)

(21) Appl. No.: 18/965,357

(22) Filed: Dec. 2, 2024

Related U.S. Application Data
(60) Provisional application No. 63/605,208, filed on Dec. 1, 2023.

(51) Int. Cl. G02B 6/40; G02B 6/38

(52) U.S. Cl. CPC G02B 6/406; G02B 6/3825

(57) ABSTRACT

In a pluggable multifiber connector module comprises, a plurality of VSFF connector units extend forward from a main module body. The main module body defines a breakout chamber and at least one multifiber plug receptacle. A fiber breakout assembly is received in the breakout chamber for making optical connections from the multifiber plug mated with the at least one multifiber plug receptacle to each of the plurality of VSFF connector units, whereby the fiber breakout assembly breaks out fiber paths from the multifiber cable among the plurality of VSFF connector units. The pluggable multifiber connector module is configured to be plugged into a VSFF adapter as a unit such that each of the VSFF connector units mates with a respective VSFF receptacle of the VSFF adapter, whereby via a single plug-in action, the pluggable multifiber connector module can break out fiber paths from the multifiber cable among the VSFF receptacles.

### CROSS REFERENCE TO RELATED APPLICATION

This application claims priority to U.S. Provisional Patent Application No. 63/605,208, filed Dec. 1, 2023, which is hereby incorporated by reference in its entirety.

### FIELD

This disclosure generally relates to a pluggable multifiber connector module, and more specifically, to a pluggable multifiber connector module that converts a single multifiber cable plug into a plurality of very small form factor (VSFF) connector units that can plug into a VSFF adapter as a unit.

### BACKGROUND

The Internet has led to unprecedented growth in communication networks. Network providers require evermore advanced network systems to advance reliability, speed, and data throughput. Fiber optic network systems are preferred for certain applications. Network providers want fiber optic network systems to be easy to install at high densities.

Certain solutions have included deployment of high-density interconnect panels. High-density interconnect panels may be designed to consolidate the increasing volume of interconnections necessary to support the fast-growing networks into a compacted form factor, thereby increasing quality of service and decreasing costs such as floor space and support overhead. However, room for improvement in the area of data centers, specifically as it relates to fiber optic connections, still exists. For example, manufacturers of connectors and adapters are always looking to reduce the size of the devices, while increasing ease of deployment, robustness, and modifiability after deployment. In particular, more optical connectors may need to be accommodated in the same footprint previously used for a smaller number of connectors in order to provide backward compatibility with existing data center equipment.

To address this need, the industry has recently developed a new line of very small form factor (VSFF) interconnect products. These products are based on various VSFF interface designs that specify the geometry for mating male (plug) and female (receptacle) connector components. Prominent VSFF interconnects include the SN, SN-MT, MDC, and MMC interconnects. On average, VSFF interconnects enable more than two-times the fiber connection density of legacy small form factor (SFF) fiber optic interconnects such as MPO and LC.

### SUMMARY

In one aspect, a pluggable multifiber connector module comprises a plurality of VSFF connector units. Each VSFF connector unit comprises an individual VSFF ferrule holder and at least one fiber optic ferrule retained in the respective VSFF ferrule holder. A main module body has a longitudinal axis and front end portion and a rear end portion spaced apart along the longitudinal axis. The main module body defines a breakout chamber between the front end portion and the rear end portion. The front end portion of the main module body is coupled to the VSFF connector units such that each of the VSFF connector units extends forward from the front end portion of the main module body. The main module body defines at least one multifiber plug receptacle at the rear end portion for mating with a multifiber plug terminating a multifiber cable. A fiber breakout assembly comprises optical fibers received in the breakout chamber. The fiber breakout assembly is configured to make optical connections from the multifiber plug mated with the at least one multifiber plug receptacle to each fiber optic ferrule of the plurality of VSFF connector units, whereby the fiber breakout assembly breaks out fiber paths from the multifiber cable among the plurality of VSFF connector units. The pluggable multifiber connector module is configured to be plugged into a VSFF adapter as a unit such that each of the VSFF connector units mates with a respective VSFF receptacle of the VSFF adapter, whereby via a single plug-in action, the pluggable multifiber connector module can break out fiber paths from the multifiber cable among the VSFF receptacles.

Other aspects will be in part apparent and in part pointed out hereinafter.

### BRIEF DESCRIPTION OF THE DRAWINGS

FIG. 1 is perspective of a pluggable multifiber connector module in accordance with the present disclosure;

FIG. 2 is another perspective of the pluggable multifiber connector module with a multifiber plug thereof removed to reveal a multifiber plug receptacle at a rear end portion of a main module body;

FIG. 3 is another perspective of the pluggable multifiber connector module in which the multifiber plug and a release collar has been removed to reveal internal components;

FIG. 4 is another perspective of the pluggable multifiber connector module in which, the multifiber plug, the release collar, pullback release elements, and a cover have been removed to further reveal internal components;

FIG. 5 is an enlarged fragmentary plan view of the pluggable multifiber connector module in which the multifiber plug, the release collar, and the cover have been removed;

FIG. 6 is a perspective of the pluggable multifiber connector module in which the pullback release element of one VSFF connector unit has been removed to reveal a VSFF ferrule holder of the VSFF connector unit;

FIG. 7 is an enlarged fragmentary cross section of the pluggable multifiber connector module;

FIG. 8 is perspective of one pullback release element of the pluggable multifiber connector module;

FIG. 9 is another perspective of the pluggable multifiber connector module in which, the multifiber plug, the release collar, and the pullback release elements have been removed;

FIG. 10 is yet another perspective of the pluggable multifiber connector module in which the multifiber plug, the release collar, and the pullback release elements have been removed;

FIG. 11 is a perspective of the main module body of the pluggable multifiber connector module;

FIG. 12 is another perspective of the main module body of the pluggable multifiber connector module;

FIG. 13 is a perspective of the release collar of the pluggable multifiber connector module;

FIG. 14 is another perspective of the release collar of the pluggable multifiber connector module;

FIG. 15 is a perspective of another embodiment of a pluggable multifiber connector module in accordance with the present disclosure, wherein multifiber plugs are unplugged from multifiber plug receptacles at a rear end portion of a main module body thereof;

FIG. 16 is a perspective similar to FIG. 15 but shows the multifiber plugs plugged into the multifiber plug receptacles;

FIG. 17 is a perspective of the pluggable multifiber connector module of FIGS. 15-16 with the multifiber plugs removed;

FIG. 18 is a plan view of the pluggable multifiber connector module of FIGS. 15-16;

FIG. 19 is an elevation of the pluggable multifiber connector module of FIGS. 15-16;

FIG. 20 is an exploded perspective of the pluggable multifiber connector module of FIGS. 15-16, excluding the multifiber plugs;

FIG. 21 is an exploded perspective similar to FIG. 20, but showing some of the pieces that are exploded apart in FIG. 20 assembled together as a subassembly; and

FIG. 22 is another exploded perspective similar to FIGS. 21 and 22, showing the pluggable multifiber connector module of FIGS. 15-16 in a more assembled state than FIG. 21.

Corresponding parts are given corresponding reference characters throughout the drawings.

### DETAILED DESCRIPTION

By way of introduction, this disclosure is directed to a pluggable multifiber connector module. As will be explained in further detail below, the pluggable multifiber connector module is a device with multiple VSFF connector units at its front end. With one plug- in motion, each of the VSFF connector units are mated simultaneously with a VSFF adapter to establish multiple, broken-out optical connections. In this, the pluggable multifiber connector module described below is similar to a VSFF uniboot connector. However, the pluggable multifiber connector module disclosed hereafter differs from VSFF uniboot connectors in that the VSFF connector units at the front end do not directly terminate the multifiber cable(s) at the rear end. Instead, as will be explained below, the pluggable multifiber connector module has one or more integrated multifiber plug receptacles toward its rear end for mating with one or more multifiber plugs terminating multifiber cables. Between the integrated plug receptacles and the VSFF connector units, a fiber breakout assembly breaks out fiber paths from the multifiber plug receptacle(s) among the VSFF connector units. Thus, in addition to serving the role of a traditional uniboot connector, the pluggable multifiber connector module detailed below also performs the function of a traditional fiber optic cassette. Those skilled in the art will recognize that this combined functionality has many potential applications in a modern fiber optic network installation. Moreover, the inventors believe that the pluggable multifiber connector module of the present disclosure makes it easier for existing fiber optic installations that use legacy interconnect components to upgrade higher density VSFF components.

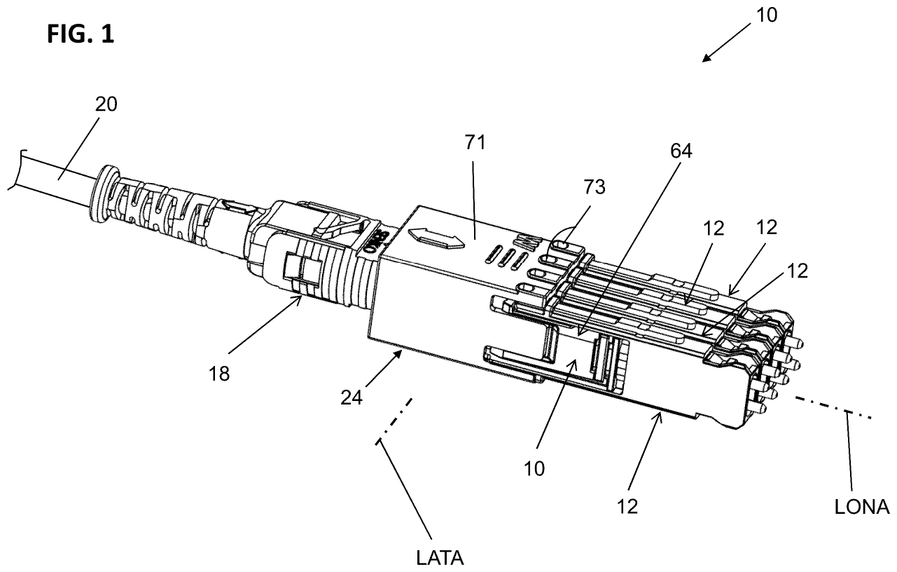

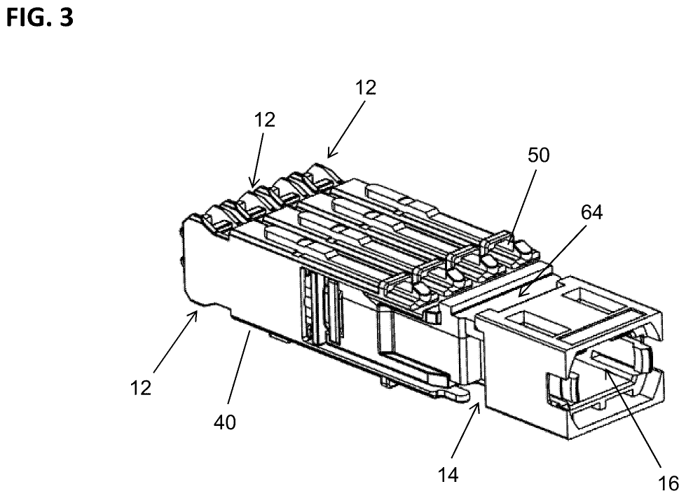

Referring to FIGS. 1-5, an exemplary embodiment of a pluggable multifiber connector module in the scope of the present disclosure is generally indicated at reference number 10. The pluggable multifiber connector module 10 comprises a plurality of very small form factor (“VSFF”) connector units 12 configured to mate with a multiport VSFF adapter (not shown) and a module body 14 that includes an integrated multifiber plug receptacle 16 for mating with a multifiber plug 18 that terminates a multifiber cable 20. Inside the main module body 14 is a fiber breakout assembly 22 that breaks out fiber paths from the multifiber plug 18 to the VSFF connector units 12. As will be explained in further detail below, the pluggable multifiber connector module 10 is configured to be plugged into a VSFF adapter as a unit such that each of the VSFF connector units 12 mates with a respective VSFF receptacle of the VSFF adapter simultaneously. Via a single plug-in action, the pluggable multifiber connector module breaks out fiber paths from the multifiber cable 20 among the VSFF receptacles. The pluggable multifiber connector module 10 further comprises a release collar 24 disposed around the main module body 14 and configured to actuate release mechanisms of each of the VSFF connector units 12 to simultaneously release them from the VSFF adapter.

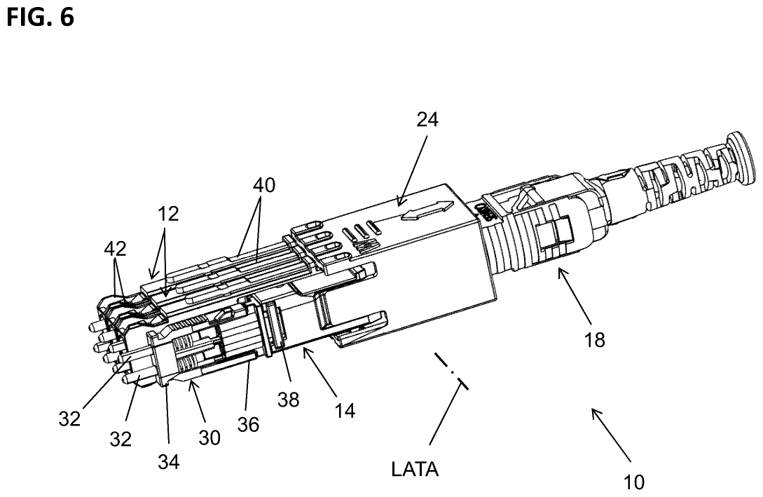

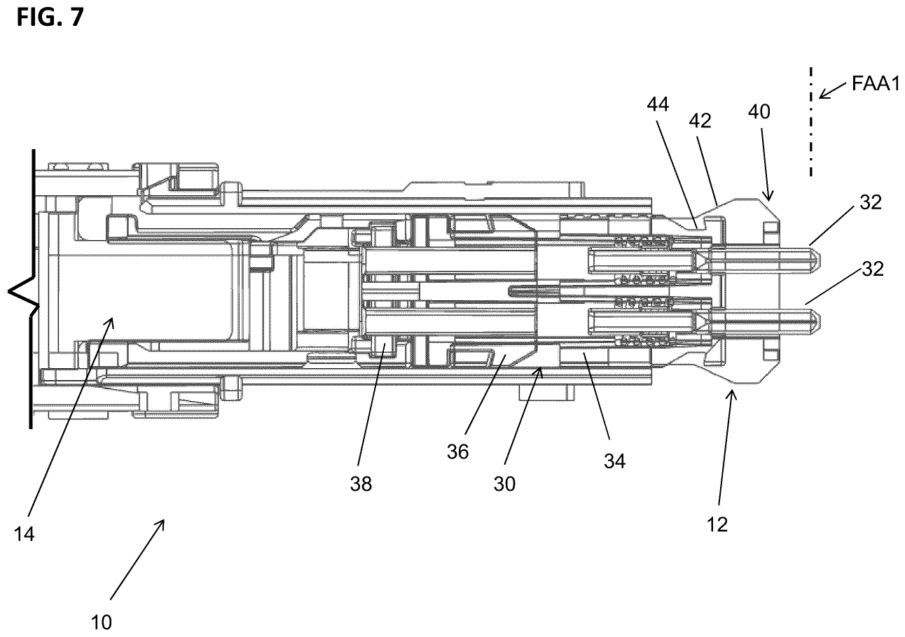

Referring to FIGS. 6 and 7, each VSFF connector unit 12 comprises an individual VSFF ferrule holder 30 and at least one fiber optic ferrule 32 retained in the respective VSFF ferrule holder. In the illustrated embodiment, the VSFF connector units 12 are SN duplex connector units configured for mating with an SN adapter (not shown). Hence, in the illustrated embodiment, each VSFF ferrule holder 30 comprises an SN front body 34 and an SN back body 36. The front body 34 and the back body 36 are secured together to hold two spring-loaded single-fiber LC ferrule assemblies 32 such that the two fibers terminated therein are spaced apart along a fiber alignment axis FAA1 (FIG. 7). In other embodiments of pluggable multifiber connector modules 10 in the scope of the present disclosure (some of which are discussed below), the VSFF connector units are based on other types of VSFF connectors. For example, it is expressly contemplated that a pluggable multifiber connector module 10 in the scope of the present disclosure can include a plurality of VSFF connector units that are SN-MT connector units, MMC connector units, or MDC connector units. In principle, the VSFF connector units 12 at the front of the pluggable multifiber connector module 10 could also be replaced with other types of connectors (e.g., SFF connectors such as LC duplex connectors) without departing from the scope of the disclosure.

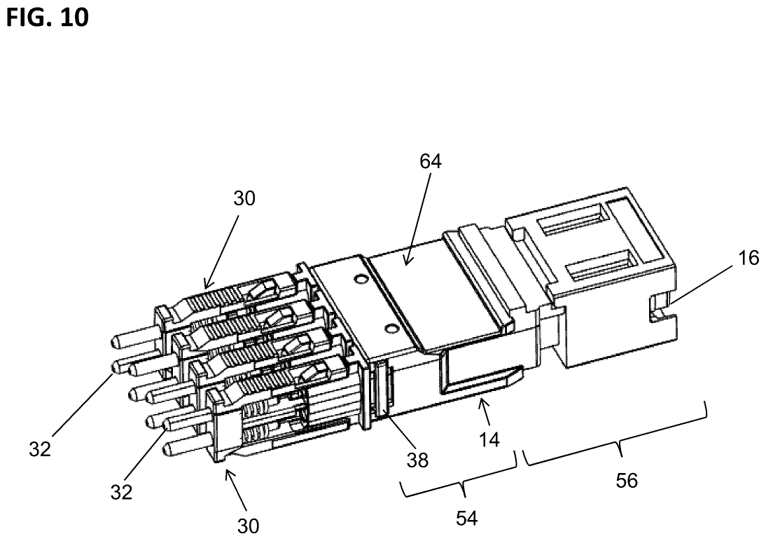

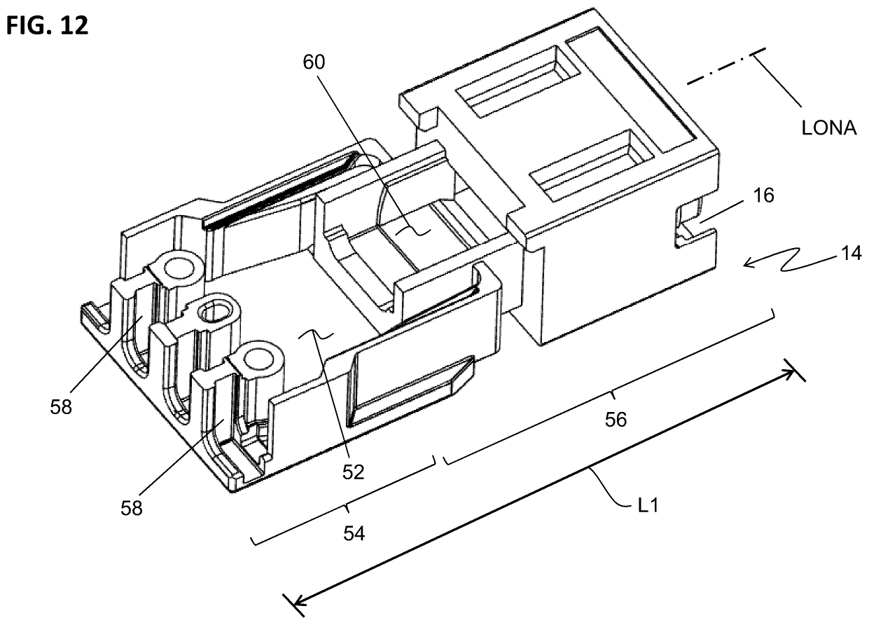

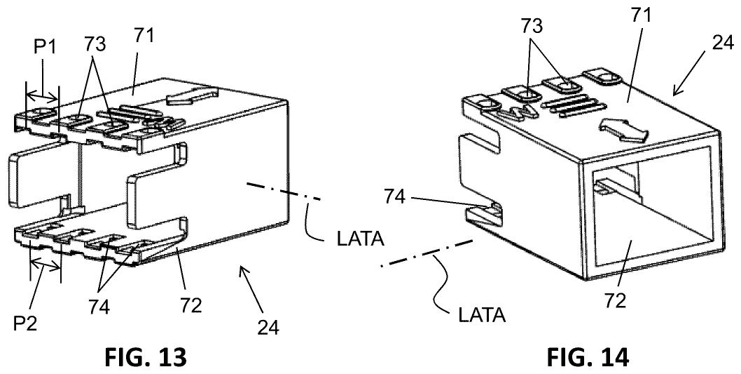

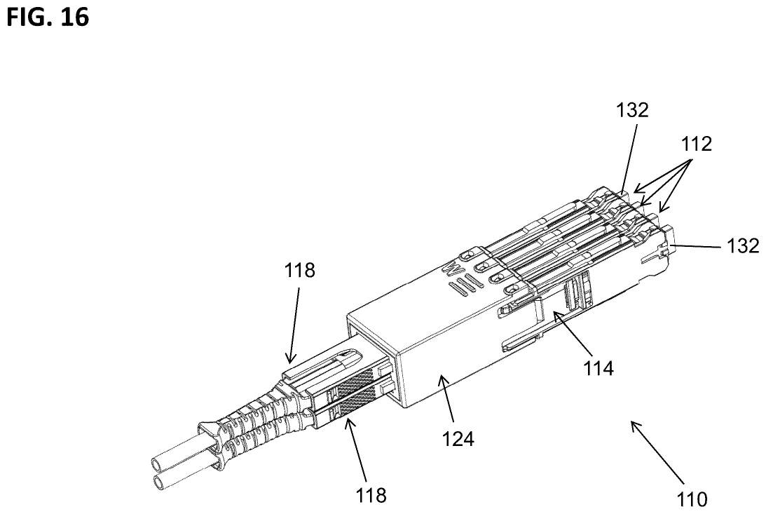

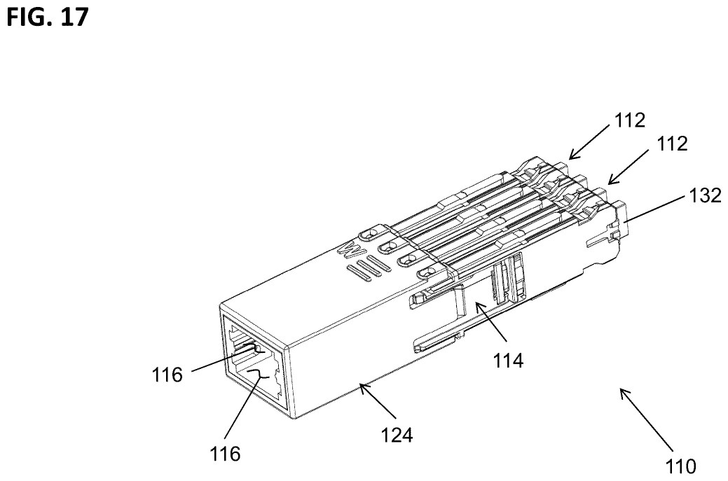

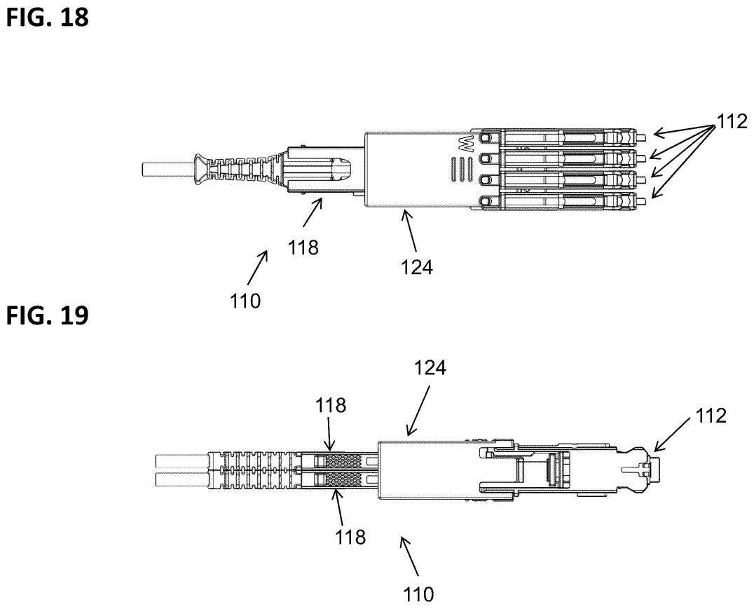

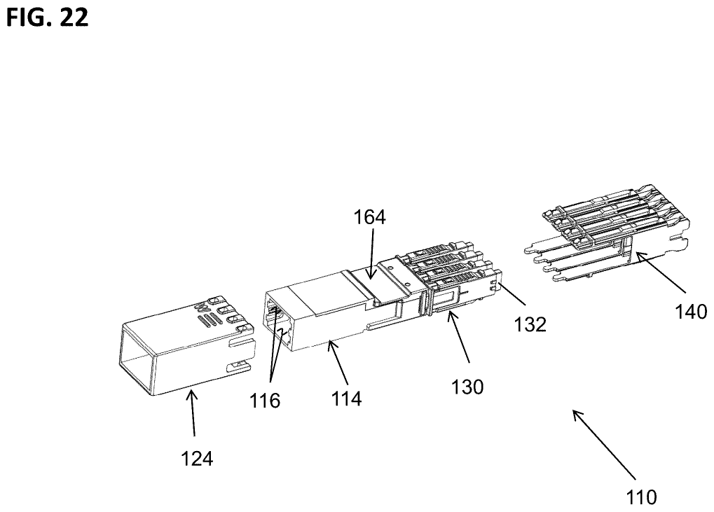

The illustrated VSFF ferrule holders 30 are essentially the same as the “inner connector subassemblies” of the uniboot connector depicted in FIGS. 1-31 of US Patent Application Publication No. 2023/0135807. US Patent Application Publication No. 2023/0135807 is hereby incorporated by reference as to all aspects of these “inner connector subassemblies” in FIGS. 1-31. Notably, the VSFF ferrule holders 30 comprise back flanges 38 that are configured to couple to a front portion of the main module body 16 in the same way that the back flanges of the inner connector subassemblies depicted in FIGS. 1-31 of US Patent Application Publication No. 2023/0135807 couple to the “body base” of the “back body assembly.”

Each VSFF connector unit 12 further comprises a pullback release element 40 disposed on the respective ferrule holder 30. In general, a pullback release element can comprise any actuator for a fiber optic connector unit that is configured to be pulled rearward to selectively unlatch the connector from the VSFF receptacle. In the illustrated embodiment, the pullback release element 40 is an SN-style outer housing that is configured to be displaced rearward in relation to the respective ferrule holder 30, whereby ramp features 42 on the outer housing bear against opposing latch arms of a mating SN adapter (not shown) to spread the latch arms and unlatch them from latch recesses 44 on opposite sides of the ferrule holder 30.

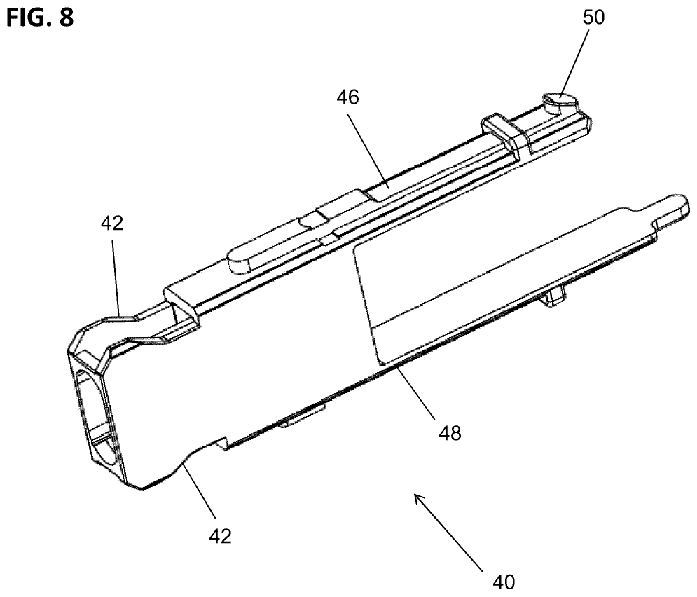

Referring to FIG. 8, the SN-style outer housings 40 are substantially similar to the “front housings” of the uniboot connector depicted in FIGS. 1-31 of US Patent Application Publication No. 2023/0135807. US Patent Application Publication No. 2023/0135807 is hereby further incorporated by reference as to all aspects of these “front housings” in FIGS. 1-31. Like the front housings from US Patent Application Publication No. 2023/0135807, each outer housing 40 of the illustrated pluggable multifiber connector module 10 has a top wall 46 and a bottom wall 48. The rear section of each top wall 40 includes a latch protrusion 50 configured to latch with features on release collar 24. As will be explained in further detail below, the latch protrusions 50 can latch with the release collar in two different orientations in order to selectively adjust the connector pitch the VSFF connector units 12 along a lateral axis LATA of the pluggable multifiber connector module 10. As explained in US Patent Application Publication No. 2023/0135807, adjusting the lateral spacing or pitch of the VSFF connector units 12 along the lateral axis LATA enables the pluggable multifiber connector module 10 to mate with different types of SN adapters (e.g., adapters with internal partition walls and optional shutters or higher density adapters without internal partition walls between individual VSFF receptacles).

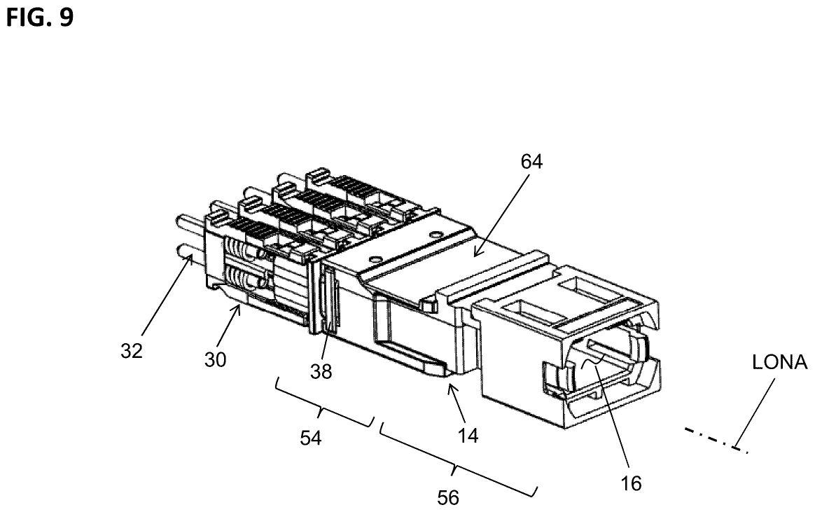

Referring to FIGS. 9-12, the main module body 14 has a longitudinal axis LONA and front end portion and a rear end portion spaced apart along the longitudinal axis. As explained in further detail below, the front end portion is configured to connect to the VSFF connector units 12, the rear end portion is configured to form the multifiber plug receptacle 16, and the area between the front and rear end portions is configured to receive the fiber breakout assembly 22 so that the fiber breakout assembly can break out signal paths terminated by a multifiber plug 18 mated with the multifiber plug receptacle among the plurality of VSFF connector units 12.

The illustrated main module body 14 performs a similar function to a conventional cassette body of the type that is widely used in fiber optic networks to break out signals between one multifiber cable and a plurality of duplex cables. In an exemplary embodiment, the main module body has a length L1 extending along the longitudinal axis LONA from the front end portion to the rear end portion in an inclusive range of from 25 mm to 50 mm. In addition, the main module body 14 can suitably have cross-sectional dimensions that fit entirely within a QSFP footprint. Those skilled in the art will recognize that this is a substantial space savings in comparison with the conventional MPO-to-LC cassettes that are in wide use.

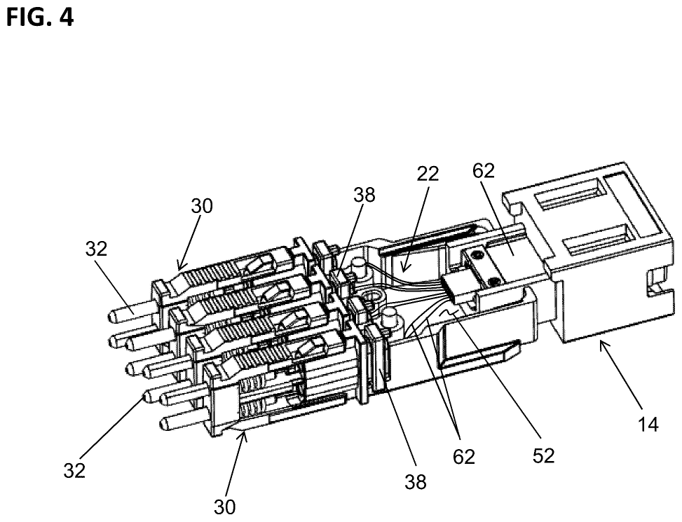

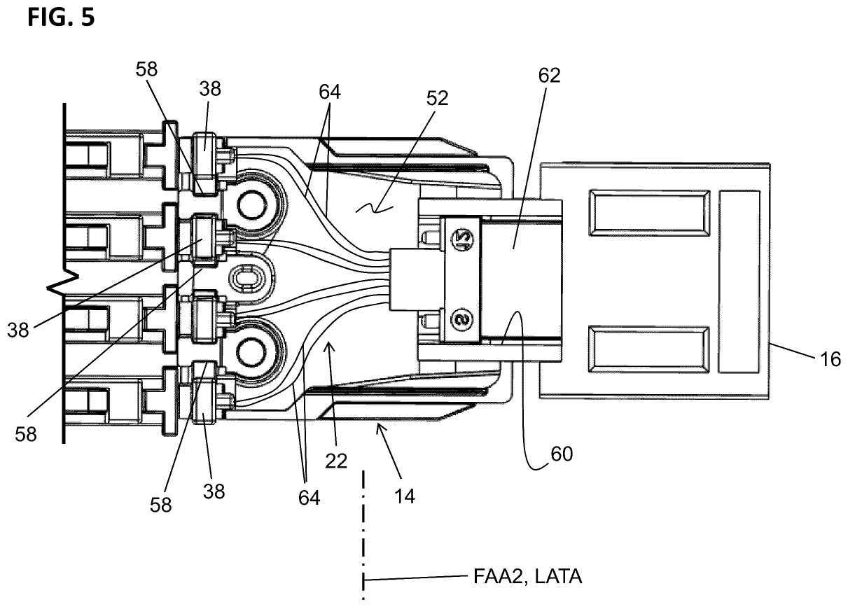

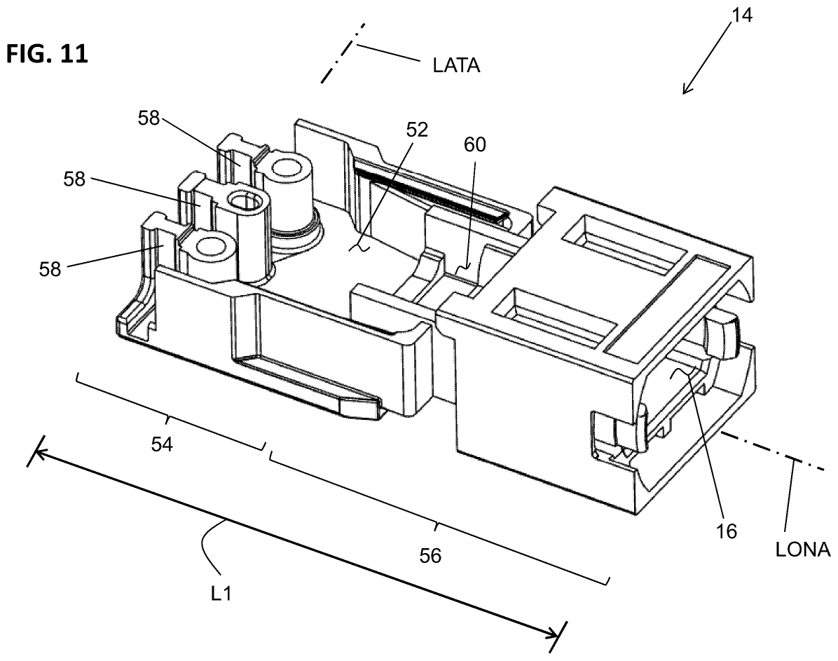

The main module body 14 defines a breakout chamber 52 (FIGS. 11-12) between the front end portion and the rear end portion. The breakout chamber 52 is sized and arranged for receiving the fiber breakout assembly 22 therein (see FIGS. 4-5). In the illustrated embodiment, the main module body 14 defines a top opening above the breakout chamber 52. This allows for the fiber breakout assembly 22 to be assembled and/or loaded into the fiber breakout chamber 52 through the top opening. The pluggable multifiber connector module 10 further comprises a cover 64 configured to be secured to the main module body 14 to cover the top opening after the fiber breakout assembly 22 has been assembled and loaded into the breakout chamber 52.

In general, the main module body 14 is formed in two sections, (i) a front section 54 that contains most of the breakout chamber 52 and attaches to the VSFF connector units 12 and (ii) a rear section 56 that forms the multifiber plug receptacle 16. In the illustrated embodiment, the front section 54 and rear section 56 of the main module body 14 are formed from a single monolithic piece of material, but the two sections could be formed from separate pieces that are attached together in other embodiments.

The front section 54 is similar to the front section of the “body base” of the “back body assembly” of the uniboot connector in FIGS. 1-31 of US Patent Application Publication No. 2023/0135807. For example, the front section 54 includes a plurality of ferrule holder retainers 58 spaced apart along the lateral axis LATA that couple to the back flanges 38 of the VSFF ferrule holders 30 in essentially the same way that the corresponding “adjustment openings” of the “body base” in FIGS. 1-31 of US Patent Application Publication No. 2023/0135807. As will thus be understood, each ferrule holder 30 is configured to retain a respective one of the VSFF ferrule holders 30 such that the VSFF ferrule holders are axially affixed in relation to the main body 14 along the longitudinal axis LONA but permitted to move laterally with respect to the main body in a limited range of motion to allow for adjustment of the connector pitch of the VSFF connector units 12. US Patent Application Publication No. 2023/0135807 is hereby further incorporated by reference as to all aspects pertaining to the front half of the “body base” in FIGS. 1-31.

The rear section 56 of the main module body 14 is constructed as an MT ferrule-to-multifiber plug adapter. In the illustrated embodiment, the multifiber plug 12 is an MPO connector plug 18 and the multifiber plug receptacle 16 is an MPO receptacle. Thus, the illustrated rear section 56 is constructed as an MT ferrule-to-MPO adapter. Other embodiments can be configured for mating with other types of multifiber plugs (e.g., SN-MT plugs as described below, MMC plugs, or still other types of multifiber plugs) at the rear end. Opposite the MPO receptacle 16 is an MT ferrule receptacle 60 configured to receive an MT ferrule 62 of the fiber breakout assembly 22 (FIGS. 4-5) and position the MT ferrule so that an optical connection between the MT ferrule and the MPO connector plug 18 is made when the MPO connector plug is mated with the MPO receptacle. In the illustrated embodiment, the MT ferrule-to-multifiber plug adapter incorporated into the rear section 56 has a similar interface design to the adapter disclosed in U.S. Pat. No. 10,761,273, which is hereby incorporated by reference for a more detailed understanding the features of the MT ferrule-to-MPO adapter incorporated into the rear section 56 of the illustrated main module body 14. Like the “holder” for the ferrule in U.S. Pat. No. 10,761,273, the illustrated MT ferrule receptacle 60 allows the MT ferrule 62 to be top-loaded into the receptacle. This makes it relatively simple to install the MT ferrule 2 through the top opening of the main module body 14 during assembly.

Referring again to FIGS. 4-5, the fiber breakout assembly 22 comprises optical fibers 64 received in the breakout chamber 52. In general, the fiber breakout assembly 22 is configured to make optical connections from the multifiber plug 18 mated with the multifiber plug receptacle 16 to each fiber optic ferrule 32 of the plurality of VSFF connector units 12, whereby the fiber breakout assembly breaks out fiber paths from the multifiber cable 20 among the plurality of VSFF connector units. The optical fibers 64 of the fiber breakout assembly 22 have first end portions terminated by the multifiber ferrule 62 and second end portions terminated by the fiber optic ferrules 32 of the plurality of VSFF connector units 12. In the illustrated embodiment, the fiber optic breakout assembly 22 includes exactly 8 fibers broken out among four duplex VSFF connector units 12. But it will be understood that other embodiments can have other fiber counts. For example, in certain embodiments, pluggable multifiber connector modules in accordance with the present disclosure can have fiber breakout assemblies that include exactly 8, 16, 32, 48, or 64 optical fibers

FIG. 5 shows how the MT ferrule 62 of the fiber breakout assembly 22 has a fiber alignment axis FAA2 that extends parallel to the lateral axis LATA of the pluggable multifiber connector module 10. By contrast, as shown in FIG. 7, the fiber alignment axes FAA1 of the VSFF connector units 12 are oriented perpendicular to the lateral axis LATA and thus perpendicular to the fiber alignment axis FAA2 of the MT ferrule 62. Accordingly, it can be seen that the fiber breakout assembly 22 reorients the fibers between the MT ferrule 62 and the ferrules 32 of the VSFF connector units 12.

Referring to FIGS. 1-2 and 13-14, the release collar 24 is disposed on the main module body 14 such that the release collar is movable in relation to the main module body along the longitudinal axis LONA. The release collar 24 is configured to operatively couple to the VSFF outer housings 40 (broadly, pullback release elements) of the VSFF connector units 12 such that the release element is movable rearward in relation to the main module body 14 to simultaneously pull the VSFF outer housings rearward to unlatch all of the VSFF connector units from the VSFF receptacles (not shown) at once. In the illustrated embodiment, that means the release collar 24 simultaneously displaces each of the VSFF outer housings 40 rearward in relation to the VSFF ferrule holders 30 to unlatch each VSFF connector unit from its respective VSFF receptacle. But in other embodiments, the release collar may pullback other types of pullback release elements that function in other ways (e.g., the pullback latch release arms used in MDC and MMC VSFF connectors). To provide improved finer access to the release collar 24 in high density fiber optic installations, a pull tab (not shown) may be added to extend rearward from the release collar.

In the illustrated embodiment, the release collar 24 has essentially the same construction as the front half of the “rear housing” of the uniboot connector depicted in FIGS. 1-31 of US Patent Application Publication No. 2023/0135807. Accordingly, US Patent Application Publication No. 2023/0135807 is further incorporated by reference as to what it teaches about the front half of the “rear housing” in FIGS. 1-31. The release collar 24 comprises a first wall 71 and a second wall 72 opposite the first wall. The first wall 71 comprises a plurality of release element couplers 73 spaced apart along a lateral axis LATA at a first pitch P1, and the second wall 72 comprises a plurality of release element couplers 74 spaced apart along the lateral axis at a second pitch P2. The second pitch P2 is less than the first pitch P1.

The latch protrusions 50 on the VSFF outer housings 40 form coupling features configured for releasably coupling to the release element couplers 73, 74. The release collar 24 is selectively positionable on the main module body 14 in (i) a first orientation in which the first wall 71 is on top and the second wall 72 is on bottom and (ii) a second orientation in which the second wall is on top and the first wall is on bottom. When the release collar 24 is positioned on the main module body 14 in the first orientation, the release element couplers 73 on the first wall 71 couple to the latch protrusions 50 to set the VSFF connector units 12 at the first pitch P1. When the release collar 24 is positioned on the main module body 14 in the second orientation, the release element couplers 74 on the second wall 72 couple to the latch protrusions 50 to set the VSFF connector units 12 at the second pitch P2. In both the first orientation and the second orientation, the latch protrusions 50 coupled to the respective set of release element couplers 73, 74 links the VSFF outer housings 40 to the release collar 24 so that the VSFF outer housings move with release collar when the release collar is pulled rearward. This displaces the VSFF outer housings 40 in relation to the VSFF ferrule holders 30 to actuate the VSFF connector units 12 for unlatching from a mating VSFF adapter.

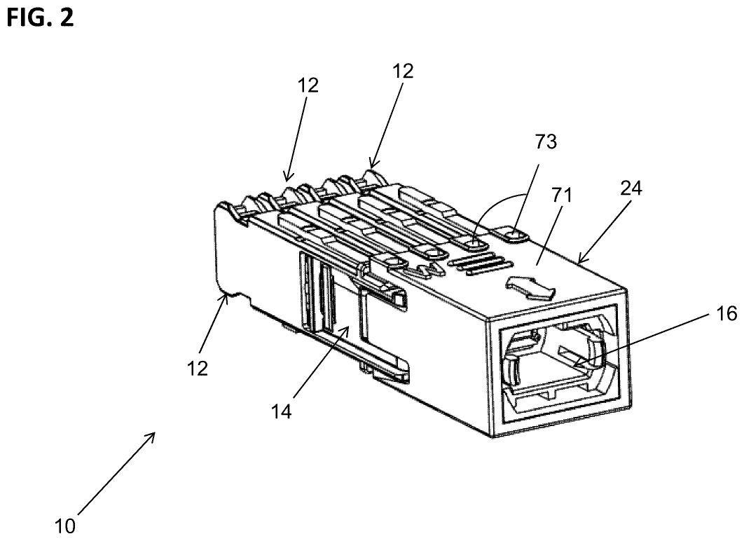

Referring back to FIGS. 1 and 2, the pluggable multifiber connector module 10 is thought to provide several potential benefits to users of fiber optic networks. First, it provides a much higher density alternative to conventional fiber optic cassettes for breaking out signals from a multifiber plug 18 to a plurality of individual VSFF receptacles (not shown). When the multifiber plug 18 is plugged into the multifiber plug receptacle 16 and the VSFF connector units 12 are plugged into a VSFF adapter (not shown), the pluggable multifiber connector module 10 breaks out the fiber paths that were carried by the multifiber cable 20 into four different VSFF receptacles. Moreover, the breakout is achieved within a footprint approximately equal to a QSFP footprint (e.g., within ±15% of QSFP dimensions). Thus, similar functionality to a conventional fiber optic cassette is achieved in a substantially smaller physical network footprint.

Those skilled in the art will recognize, therefore, that the pluggable multifiber connector module 10 can be employed in numerous network configuration where fiber breakout is desired. For example, the pluggable multifiber connector module 10 can be used as one-for-one alternative for the uniboot connector shown in FIGS. 1-31 of US Patent Application Publication No. 2023/0135807. Moreover, pluggable multifiber connector modules in accordance with the present disclosure can be used in place of uniboot connectors in any of the fiber optic breakout scenarios described in US Patent Application Publication No. 2023/0099201.

The pluggable multifiber connector module 10 is also particularly well suited to up-converting legacy fiber optic connector applications to modern VSFF connector formats. For example, in any existing fiber optic installation that uses MPO plugs for eight fiber cables, the MPO plug 18 can be plugged into the receptacle 16 of the main body 14 to convert MPO cable 20 to an SN duplex cable terminated by four SN duplex connector units 12. It will be appreciated that different pluggable multifiber connector module configurations could be used to convert other types of legacy multifiber connector cables to modern VSFF connectors.

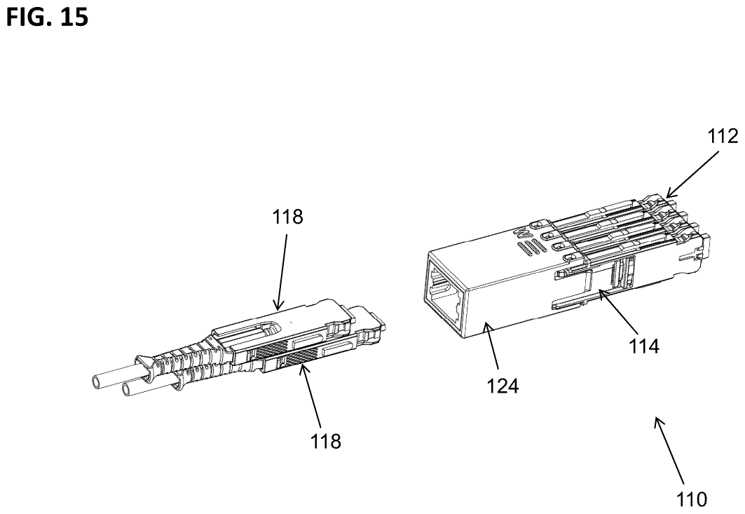

Referring to FIGS. 15-22, another embodiment of a pluggable multifiber connector module in accordance with the present disclosure is generally indicated at reference number 110. The pluggable multifiber connector module 110 is similar to the connector module 10, and parts of the pluggable multifiber connector module 110 that correspond to parts of the pluggable multifiber connector module 10 will be given the same reference number, plus 100. In general, the pluggable multifiber connector module 110 comprises a plurality of VSFF connector units 112, a main module body 114, a cover 164 for the main module body, a fiber breakout assembly 122 in the main module body, and a release collar 124. Unlike the pluggable multifiber connector module 10, the VSFF connector units 112 in the pluggable multifiber connector module 110 are multifiber VSFF connector units, specifically SN-MT connector units. Each SN-MT connector unit 112 comprises an SN-MT ferrule holder 130 that holds a spring loaded MT ferrule 132. In the illustrated embodiment, each MT ferrule terminates 8 fibers, so the pluggable multifiber connector module 110 terminates a total of 32 fibers. Rather than an MPO plug receptacle 16, the main module body 114 includes two SN-MT receptacles 116 at the rear end portion. The SN-MT receptacles 116 are configured to mate with two 16-fiber SN-MT connector plugs 118, which are another type of multifiber plug in the scope of the present disclosure.

The pluggable multifiber connector module 110 is constructed to function in essentially the same way as the pluggable multifiber connector module 10 but accommodates a greater fiber count. In terms of similarities, the release collar 124 is configured to operatively couple to SN-MT outer housings 140 (broadly, pullback release elements) in either of two orientations to change the connector pitch at which the SN-MT connector units 112 are spaced apart laterally. In either orientation, the release collar 124 is configured to simultaneously pull the SN-MT outer housings rearward 140 to unlatch all of the SN-MT connector units from the SN-MT receptacles (not shown) at one time.

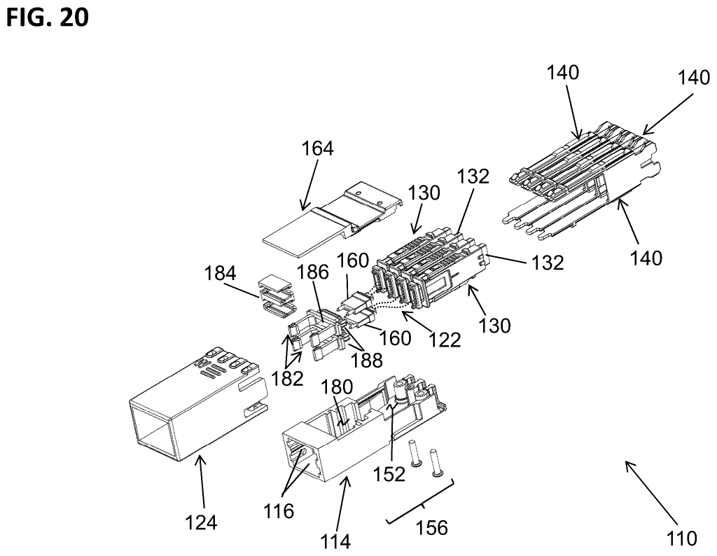

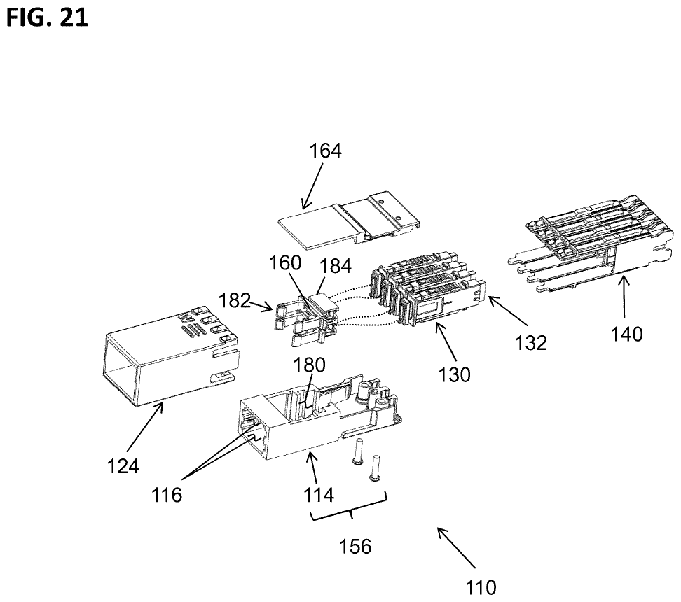

To accommodate the greater fiber count in the pluggable multifiber connector module 110, the rear section 156 of the main module body 114 is changed to include two SN-MT receptacles 216 on the plug side of the MT ferrule-to-multifiber plug adapter and to accept two MT ferrules 160 on the receptacle side of the MT ferrule-to-multifiber plug adapter. More specifically, the rear section 156 comprises an open-top receiver 180 configured to accept an assembly of two SN-MT latch arm components 182, two MT ferrules 160, and a ferrule retention clip 184. As shown in FIGS. 20-21: each MT ferrule 160 can be inserted longitudinally into an opening 186 in a respective SN-MT latch arm component 182; then the ferrule retention clip can be slid laterally onto bosses 188 formed on the latch arm components 182 to retain the MT ferrules 160 in position; and finally the entire assembly can be loaded into the receiver 180 through the top opening of the breakout chamber 152. The way the ferrule retention clip 184 secures the MT ferrules 160 in place in relation to the latch arm components 182 is similar to what is disclosed in U.S. Pat. No. 11,467,354. U.S. Pat. No. 11,467,354 is hereby incorporated by reference for its explanation of how “stoppers,” similar to the ferrule retention clip 184, engage with “outer frames,” similar to the bosses 188, to retain ferrules in SN-MT-type latch arm components.

It can be seen that the pluggable multifiber connector module 110 provides a single-plug-in connector that can be used to make a simultaneous connection of 32 fibers to four SN-MT receptacles. In addition, the pluggable multifiber connector module 110 provides a small-form factor device for effectively breaking out 32 fiber paths among four VSFF multifiber connectors.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A pluggable multifiber connector module, the pluggable multifiber connector module comprising:
a plurality of VSFF connector units, each VSFF connector unit comprising an individual VSFF ferrule holder and at least one fiber optic ferrule retained in the respective VSFF ferrule holder;
a main module body having a longitudinal axis and front end portion and a rear end portion spaced apart along the longitudinal axis, the main module body defining a breakout chamber between the front end portion and the rear end portion, the front end portion of the main module body coupled to the VSFF connector units such that each of the VSFF connector units extends forward from the front end portion of the main module body, the main module body defining at least one multifiber plug receptacle at the rear end portion for mating with a multifiber plug terminating a multifiber cable; and
a fiber breakout assembly comprising optical fibers received in the breakout chamber, the fiber breakout assembly configured to make optical connections from the multifiber plug mated with the at least one multifiber plug receptacle to each fiber optic ferrule of the plurality of VSFF connector units, whereby the fiber breakout assembly breaks out fiber paths from the multifiber cable among the plurality of VSFF connector units;
wherein the pluggable multifiber connector module is configured to be plugged into a VSFF adapter as a unit such that each of the VSFF connector units mates with a respective VSFF receptacle of the VSFF adapter, whereby via a single plug-in action, the pluggable multifiber connector module can break out fiber paths from the multifiber cable among the VSFF receptacles.

2. The pluggable multifiber connector module of claim 1, wherein the fiber breakout assembly comprises a multifiber ferrule mounted in the breakout chamber, the optical fibers of the fiber breakout assembly having first end portions terminated by the multifiber ferrule and second end portions terminated by the fiber optic ferrules of the plurality of VSFF connector units.

3. The pluggable multifiber connector module of claim 1, wherein the front end portion of the main module body defines a plurality of ferrule holder retainers spaced apart along a lateral axis, each ferrule holder retainer retaining a respective one of the VSFF ferrule holders such that the VSFF ferrule holders are axially fixed in relation to the main module body along the longitudinal axis.

4. The pluggable multifiber connector module of claim 3, wherein the VSFF ferrule holders are movable along the lateral axis in the ferrule holder retainers for adjusting a connector pitch of the VSFF connector units.

5. The pluggable multifiber connector module of claim 1, wherein each VSFF connector unit further comprises a pullback release element disposed on the respective ferrule holder configured to be pulled rearward to selectively unlatch the respective VSFF connector unit from the VSFF receptacle.

6. The pluggable multifiber connector module of claim 5, further comprising a release collar disposed on the main module body such that the release collar is movable in relation to the main module body along the longitudinal axis.

7. The pluggable multifiber connector module of claim 6, wherein the release collar is configured to operatively couple to the pullback release elements of the VSFF connector units such that the release element is movable rearward in relation to the main module body to simultaneously pull the pullback release elements of the VSFF connector units rearward to unlatch all of the VSFF connector units from the VSFF receptacles at once.

8. The pluggable multifiber connector module of claim 7, wherein the release collar comprises a first wall and a second wall and wherein the first wall comprises a plurality of release element couplers spaced apart along a lateral axis at a first pitch and the second wall comprises a plurality of release element couplers spaced apart along the lateral axis at a second pitch, the second pitch being less than the first pitch.

9. The pluggable multifiber connector module of claim 8, wherein the pullback release elements comprise coupling features configured for releasably coupling to the release element couplers.

10. The pluggable multifiber connector module of claim 9, wherein the release collar is selectively positionable on the main module body in a first orientation in which the first wall is on top and the second wall is on bottom and a second orientation in which the second wall is on top and the first wall is on bottom.

11. The pluggable multifiber connector module of claim 10, wherein when the release collar is positioned on the main module body in the first orientation, the release element couplers on the first wall couple to the coupling features to set the VSFF connector units at the first pitch; and wherein when the release collar is positioned on the main module body in the second orientation, the release element couplers on the second wall couple to the coupling features to set the VSFF connector units at the second pitch.

12. The pluggable multifiber connector module of claim 1, wherein the main module body defines a top opening above the breakout chamber and the pluggable multifiber connector module further comprises a cover secured to the main module body to cover the top opening.

13. The pluggable multifiber connector module of claim 1, wherein the main module body has a lateral axis, the VSFF connector units being spaced apart along the lateral axis.

14. The pluggable multifiber connector module of claim 13, wherein the fiber breakout assembly comprises a multifiber ferrule mounted in the breakout chamber, the multifiber ferrule having a fiber alignment axis parallel to the lateral axis.

15. The pluggable multifiber connector module of claim 14, wherein each VSFF connector unit has a fiber alignment axis perpendicular to the lateral axis.

16. The pluggable multifiber connector module of claim 13, wherein the fiber breakout assembly comprises first and second multifiber ferrules supported in the breakout chamber such that the first and second multifiber ferrules are spaced apart along a ferrule spacing axis perpendicular to the lateral axis.

17. The pluggable multifiber connector module of claim 1, wherein the at least one receptacle at the rear end portion of the main module body is one of an MPO receptacle, an SN-MT receptacle, and an MMC receptacle.

18. The pluggable multifiber connector module of claim 1, wherein each VSFF connector unit is one of an SN-MT connector unit, an SN duplex connector unit, an MMC connector unit, and an MDC connector unit.

19. The pluggable multifiber connector module of claim 1, wherein the main module body has a length extending along the longitudinal axis from the front end portion to the rear end portion and the length is in an inclusive range of from 25 mm to 50 mm.

20. The pluggable multifiber connector module of claim 1, wherein the fiber breakout assembly includes exactly 8, 16, 32 or 64 optical fibers.
